(19) United States
(12) Patent Application Publication
(10) Pub. No.: US 2026/0321672 A1
(43) Pub. Date: Oct. 15, 2026

(54) METHOD OF FORMING AN ELECTRICALLY CONDUCTIVE SUBSTRATE ASSEMBLY FOR AN ELECTRODE

(71) Applicant: ADVANCED BATTERY CONCEPTS, LLC, Clare, MI (US)

(72) Inventors: Shaun Bruno, Corunna, MI (US); Reed A. Shick, Midland, MI (US); Edward O. Shaffer, Farwell, MI (US); Paul Goetze, Clare, MI (US); Michael Harmon, Farwell, MI (US)

(21) Appl. No.: 19/101,412

(22) PCT Filed: Aug. 7, 2023
(86) PCT No.: PCT/US2023/071779

§ 371 Date: Feb. 5, 2025

Related U.S. Application Data
(60) Provisional application No. 63/395,641, filed on Aug. 5, 2022.

(51) Int. Cl. H01M 4/70; H01M 4/1391; H01M 4/1397; H01M 4/16

(52) U.S. Cl. CPC H01M 4/70; H01M 4/1391; H01M 4/1397; H01M 4/16

(57) ABSTRACT

A method for forming an electrically conductive substrate assembly of an electrode plate comprising: a) forming a non-conductive substrate with a plurality of conductive openings; b) filling one or more of the plurality of conductive openings with one or more electrically conductive materials; c) locating one or more current collectors on one or more surfaces of the substrate; d) optionally, bonding the one or more electrically conductive materials to the one or more current collectors; and wherein the one or more electrically conductive materials are in the form of one or more rivets.

### CROSS-REFERENCE TO RELATED APPLICATIONS

The present application claims priority to U.S. provisional patent application No. 63/395,641, filed on Aug. 5, 2022, which is incorporated herein by reference in its entirety for all purposes.

### FIELD

The present teachings relate to a method for forming an electrically conductive substrate assembly for use in an electrode plate. The electrically conductive substrate assembly may be particularly useful in bipolar battery assemblies, such as lead acid bipolar batteries.

### BACKGROUND

Substrates for bipolar electrode plates may be configured to provide electric conductivity across and through a substrate. Some substrates may include openings formed therein which are filled with an electrically conductive material, having conductive collector sheets adjacent to each opposing surface of the substrate and in electrical communication with the conductive material, and then having one or more active materials located on the collector sheets. For example, U.S. Pat. No. 8,357,469, discloses such an electrode plate configuration and is incorporated herein by reference in its entirety for all purposes.

A bipolar electrode assembly may include a non-conductive flat substrate. The substrate may be a generally rectangular prism of minimal thickness when compared to the other two dimensions of the substrate. The substrate may include a plurality of perforations referred to as through holes. The size, quantity, and distribution of the through holes may enable a through electrical connection of metallic current collectors on opposing sides of the substrate which enable proper carrying capability while isolating opposing sides of the substrate from ionic transmission.

The connections between the current collectors may be made by interposing an electrically conductive element into the through holes between the metallic current collectors. For example, one known method is by stencil printing a solder paste, or a solder paste and flux combination, into the plurality of through holes in the substrate; introducing the current collector in foil form onto the opposing surfaces of the substrate over the uncured solder paste; and then applying heat to reflow the solder, thus cooling to cure the solder joint. Thus, making the electrical connection between the current collectors and conductive elements while also sealing the through holes about the perimeters (e.g., filling any gaps between the solder paste and inner periphery of the through holes) and through the thickness of the substrate (e.g., the thickness/height of the through hole).

Other patents which teach similar and such beneficial concepts include U.S. Pat. No. 10,141,598; US Patent Publication Nos. 2020/0091521, 2021/0143514, 2022/0013760; and International Application No. PCT/US2022/017357 which are incorporated herein by reference in their entirety for all purposes.

The electrically conductive elements in the form of a solder flux may present one or more failure modes. One such failure mode may be due to the introduction of esters in the solder flux which may degrade a polymer material of the substrate (e.g., ABS). Thus, there is a need to reduce or even eliminate the need for fluxing agents, tin (Sn) dominant alloys, and/or solder stenciling.

The known methods provide elegant solutions at providing electrical conductivity through a substrate while preventing ions from passing therethrough. Notwithstanding the teachings of the prior art, there is a need to reduce or eliminate the corrosive degradation of metallic joints between opposing current collectors, such as in lead acid batteries or other oxidative environments. There is a continued need to reduce the cost of creating the electrical connections through a substrate. There is also a need to provide for flexibility in the manufacturing process of when the electrically conductive materials can be affixed into the substrate.

### SUMMARY

The present disclosure relates to a method for forming an electrically conductive substrate of an electrode plate including: a) forming a substrate with a plurality of conductive openings; b) filling one or more of the plurality of conductive openings with one or more electrically conductive materials; c) locating one or more current collectors on one or more surfaces of the substrate; d) optionally, bonding the one or more electrically conductive materials to the one or more current collectors; and wherein the one or more electrically conductive materials are in the form of one or more rivets.

The present disclosure relates to a method for forming an electrically conductive substrate assembly of an electrode plate comprising: a) forming a non-conductive substrate with a plurality of conductive openings; b) filling one or more of the plurality of conductive openings with one or more electrically conductive materials; c) locating one or more current collectors on one or more surfaces of the substrate; d) optionally, bonding the one or more electrically conductive materials to the one or more current collectors; and wherein the one or more electrically conductive materials are in the form of one or more rivets.

Rivets may be useful in sealing metals in corrosive environments and eliminate the introduction of esters in the assembly process. Riveting may provide structural support to the electrode. By using a rivet, no influence of a chemical nature is introduced into the electrode, eliminating environmental stress cracking as a failure mode. For example, no heating of plastic may be required during assembly of the electrode, thus mitigating material degradation from thermal influences. The elimination of fluxing agents, tin dominant alloys, and solder stenciling may improve the electrode plate's life by at least 10 times and reduce the number of joints needed to create an electrode plate. The use of the rivets may allow for the rivets to be inserted into the substrate before, after, or even at the same time as one or more current collectors, allowing for greater flexibility in the manufacturing process.

### BRIEF DESCRIPTION OF DRAWINGS

FIG. 1 is a perspective view of an electrode plate.

FIG. 2 is a partially exploded view of a partially assembled battery assembly.

FIG. 3 is an isometric view of a substrate.

FIG. 4 is a cross-section view of a substrate with electrically conductive material therein.

FIG. 5 is a cross-section view of a substrate with electrically conductive material therein.

FIG. 6 is a volcano plot representing materials of battery assemblies.

FIG. 7 is a volcano plot representing materials of battery assemblies.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Battery Assembly

The present disclosure generally relates to a battery assembly and may find particular use as a bipolar battery assembly. The battery assembly may have any type of suitable chemistry. The chemistry of the battery assemblies may provide for one or more lead acid batteries, nickel metal hydride batteries, lithium-ion batteries, lithium sulfur batteries, zinc batteries, aluminum batteries, sodium ion batteries, the like, or any combination thereof. In other words, the teachings disclosed herein may be applicable across a variety of battery chemistries.

The battery assembly may be a new, used, and/or reused battery assembly. New may refer to all components which have never been utilized (e.g., discharged, part of a battery assembly in operation). Used may mean that the battery assembly has been utilized at least once (e.g., at least once charge and discharge cycle). Reused may mean that one or more components of the battery assembly have previously been part of a used battery assembly, one or more components of the battery assembly have been salvaged, or both. The used battery assembly may be the same or different as the reused battery assembly. In other words, the majority or minority of the components of the reused battery assembly may be from the same used battery assembly, but after salvaging. For example, a reused battery assembly may have just one or more electrochemical cells with salvaged components therein. As another example, almost a majority or all of the electrochemical cells of the battery assembly may utilize one or more salvaged components from the same battery from previous uses or from a plurality of other used batteries. A used and/or reused battery assembly or components thereof may include those as disclosed in International PCT Publication No. WO 2022/178442, incorporated herein by reference in its entirety for all purposes.

The battery assembly may be a partial and/or a full battery pack. A battery pack may be a plurality of electrochemical cells, a plurality of battery units, or both which form the pack. The battery assembly may include one or more battery units. A plurality of battery units may be the same or different sizes, ages, chemical compositions, the like, or any combination thereof. A battery unit may be a stack of electrode plates, an electrochemical cell, or a combination thereof.

The battery assembly may include one or more stacks of a plurality of electrode plates. The plurality of electrode plates may include one or more bipolar plates, monopolar plates, dual polar plates, end plates, or any combination thereof.

The battery assembly may include one or more separators and an electrolyte. The one or more stacks may have a separator and an electrolyte located between each adjacent pair of the electrode plates. The electrolyte may be a liquid electrolyte. The electrolyte may cooperate with an anode and cathode to form an electrochemical cell.

The battery assembly may include one or more channels. The one or more channels may pass transversely through one or more electrode plates, electrolyte, separators, or a combination thereof. The one or more channels may be referred to as transverse channels. The one or more channels may be formed by openings, inserts, or both. The one or more openings, inserts, or both may be part of (e.g., attached, integral) the one or more electrode plates, separators, or both. The one or more channels may be sealed from a liquid electrolyte through which it passed. A seal may be provided by one or more inserts, other seals, or both. Alignment and interlocking of the inserts may create the seal.

One or more fluids may circulate through the one or more channels. The one or more fluids may aid controlling temperature of the battery assembly during pickling, forming, charging, discharging or any combination thereof.

### Electrode Plate Useful in a Battery Assembly

The present disclosure may relate to an electrode plate. A plurality of electrode plates may be included in part of a battery assembly. An electrode plate may be useful as bipolar plate, monopolar plate, dual polar plate, end plate, the like, or any combination thereof. An electrode plate may function as one or more electrodes, include one or more electroactive masses, be part of an electrochemical cell, form part of one or more sealing structures, or any combination thereof. A plurality of electrode plates may function to conduct an electric current (i.e., flow of ions and electrons) within the battery assembly. A plurality of electrode plates may form one or more electrochemical cells. For example, a pair of electrode plates, which may have a separator and/or electrolyte therebetween, may form an electrochemical cell. The number of electrochemical cells connected in series present in a battery assembly can be chosen to provide the desired voltage of the battery. The battery assembly design provides flexibility in the voltage that can be produced. The plurality of electrode plates can have any desired cross-sectional shape. The cross-sectional shape can be designed to fit the packaging space available in the use environment. Cross-sectional shape may refer to the shape of the plates from the perspective of the faces of the substrates. Flexible cross-sectional shapes and sizes allow preparation of the assemblies disclosed to accommodate the voltage and size needs of the system in which the batteries are utilized. The one or more electrode plates may include one or more nonplanar structures such as described in PCT Application No. PCT/US2018/033435, incorporated herein by reference in its entirety. The electrode plates may each include one or more substrates, conductive materials, active masses, current collectors, the like, or any combination thereof.

One or more electrode plates may include one or more substrates. One or more substrates may function to provide structural support for the cathode and/or the anode; as a cell partition to prevent the flow of electrolyte between adjacent electrochemical cells; cooperate with other battery components to form an electrolyte-tight seal about the bipolar plate edges which may be on the outside surface of the battery; to transmit electrons from one surface to the other; or any combination thereof. The substrate can have an overall same or similar shape as an electrode plate. A substrate may have one or more frames, inserts, openings, non-planar structures, the like, or any combination thereof. The one or more frames, inserts, and/or non-planar structures may be affixed to or integral with (e.g., formed as part of, one-piece). The substrate may have one or more frames about its periphery.

The substrate can be formed from a variety of materials depending on the function and/or the battery chemistry. The substrate may be formed from materials that are sufficiently structurally robust to provide the backbone of a desired bipolar electrode plate, withstand temperatures that exceed the melting points of any conductive materials used in the battery construction, and have high chemical stability during contact with an electrolyte (e.g., sulfuric acid solution) so that the substrate does not degrade upon contact with an electrolyte. The substrate may be formed from suitable materials and/or configured in a manner that permits the transmission of electricity from one surface of the substrate to an opposite substrate surface. The substrate may be formed from one or more electrically conductive materials, one or more electrically non-conductive materials, one or more semiconductors, or any combination thereof. A non-conductive substrate may have electrically conductive features constructed therein or thereon. The electrically conductive features may be adhered, mechanically fastened, or otherwise affixed therein or thereto the substrate. A non-conductive substrate may become part of an electrically conductive substrate assembly once electrically conductive features are assembled therein and thereon. One or more electrically conductive materials may include one or more metallic materials. One or more non-conductive materials may include one or more polymers. One or more polymers may include one or more thermoset polymers, elastomeric polymers, thermoplastic polymers, or any combination thereof. One or more polymers may include polyamide, polyester, polystyrene, polyethylene (including polyethylene terephthalate, high density polyethylene and low-density polyethylene), polycarbonates (PC), polypropylene, polyvinyl chloride, bio-based plastics/biopolymers (e.g., polylactic acid), silicone, acrylonitrile butadiene styrene (ABS), the like, or any combination thereof. For example, a combination such as PC/ABS (blends of polycarbonates and acrylonitrile butadiene styrenes) may the one or more materials. The one or more materials may include one or more composites. A composite may contain reinforcing materials. Reinforcing materials may be fibers and/or fillers commonly known in the art. As an example, two different polymeric materials may be used, such as a thermoset core and a thermoplastic shell or thermoplastic edge (e.g., frame) about the periphery of the thermoset polymer, or a conductive material disposed in a non-conductive polymer. The substrate may comprise or have at the edge of the plates a thermoplastic material that is bondable, preferably melt bondable. A substrate may be contained within a frame, one-piece with a frame (e.g., all of the same material, molded together).

One or more electrode plates may include one or more frames. One or more frames may facilitate stacking of electrode plates, formation of electrochemical cells, sealing of electrolyte within the electrochemical cells, and/or the like. The one or more frames may be located at least partially or completely about a periphery of one or more substrates. The one or more frames may be separate from or integral with (e.g., one-piece, same material) one or more substrates. For example, a frame may be integral with and located about a periphery of a substrate. For example, a frame and substrate may be formed simultaneously in a single injection molding operation. One or more frames may be a raised edge. A raised edge may facilitate stacking. A raised edge may be a raised edge projecting from one or both of the two opposing surfaces, the perimeter surface, or any combination thereof of the electrode plate (e.g., substrate). One or more sides of the raised edge may include one or more indentations so as to nest with a frame of an adjacent electrode plate or even separator. The frame may function as a separator. A frame may create a gap between two substrates by distancing two electrode plates. One or more suitable frames and edge seals may be disclosed in PCT Publication No. WO 2020/0243093, incorporated herein by reference in its entirety. The one or more frames may also cooperate with or be replaced with one or more cell seals.

A frame may be comprised of electrically non-conductive material. Electrically non-conductive material suitable for a substrate may be suitable for the frame. The use of non-conductive material may enhance sealing about the outside of the battery stack. The frame may be made of one or more polymers. The frame may be comprised of thermoplastic material. The frame may be made of a thermoplastic material which is the same or different than that of the substrate. The frame may be molded of the same polymer as the substrate such as to be integral therewith, form a one-piece component, or both. The frame of an electrode plate, end plate, or both may have similar characteristics as applicable for a frame of a separator.

One or more electrode plates may include one or more openings. The one or more openings may function to provide an opening for an attachment mechanism to pass therethrough; cooperate with one or more electrode plates, separators, end plates, and/or inserts to form part of one or more channels; house or be part of one or more seals; house one or more posts, allow for vacuum pulling, filling, and/or venting of the battery assembly; provide for circulation of a fluid through one or more channels; retain one or more electrically conductive materials; or any combination thereof. The one or more openings may have any size, shape, and/or configuration to provide any combination of the desired functions. The one or more openings may have any combination of the features as described for openings and/or holes in one or more electrode plates, end plates, and/or substrates.

One or more openings of one or more electrode plates, end plates, and/or separators may align (i.e., be concentric) with one or more openings of one or more other electrode plates, end plates, and/or separators so as to form one or more channels. The one or more channels may be referred to as one or more transverse channels. Alignment may be in a transverse direction. Transverse may mean substantially perpendicular to a face of a substrate and/or separator, across a length of the battery assembly, parallel to a longitudinal axis of the battery assembly, or a combination thereof. The transverse direction may be substantially perpendicular to the opposing surfaces of the substrates upon which a cathode and/or anode may be deposited. Transverse may mean that the general width, diameter, or both of a cross-section of the one or more openings is substantially parallel to a face of a substrate and/or separator.

One or more openings of an electrode plate, end plate, and/or substrate may have a shape and/or size similar to one or more openings of another electrode plate, end plate, and/or separator which may be adjacent. The one or more openings may have a cross-sectional shape which functions to receive an attachment mechanism, hold conductive material, receive a post, cooperate with an insert, or any combination of the desired functions of the openings. The one or more openings may have a cross-sectional shape which is generally rectangular, circular, triangular, elliptical, ovular, or any combination thereof. Cross-sectional may mean a section taken transverse to a face of the substrate. The one or more openings may have a cross-sectional width sufficient to receive one or more attachment mechanisms, one or more posts, one or more valves, hold sufficient conductive material, or any combination thereof.

The one or more openings may pass partially or completely through an insert, a base, a substrate, a separator, a reinforcement structure, a rib structure, or any combination thereof. The one or more openings may be located about or adjacent to a periphery, within an interior, or both of an end plate, electrode plate, separator, or combination thereof. The one or more openings may be distributed about a periphery, within an interior defined within the periphery, or both of an end plate, electrode plate, separator, or a combination thereof. The one or more openings may be located adjacent to one or more rib structures, between two or more rib structures, within a cell, adjacent one or more inserts, within one or more inserts, or any combination thereof. The one or more openings may form a repetitive pattern, may be aligned with one or more other openings, may be staggered or offset from one or more other openings, or any combination thereof.

The one or more openings may be machined (e.g., milled), formed during fabrication of the substrate (e.g., by a molding or shaping operation), or otherwise fabricated. The openings may have straight and/or smooth internal walls or surfaces.

The size and frequency of the openings formed in the substrate may affect the resistivity of the battery. One or more openings may have a cross-sectional width less than, equal to, or greater than a diameter of one or more other openings formed within the same end plate and/or an adjacent electrode plate. For example, one or more channel openings may have a cross-sectional width greater than one or more conductive openings. A cross-sectional width of one or more openings may be continuous, taper, or expand along the length of an opening. A cross-sectional width of one or more openings may be suitable to receive one or more posts, rods, fluids, electrolyte, conductive material, or a combination thereof therethrough. The one or more openings may have a cross-sectional width of about 0.2 mm or more, 1 mm or more, about 3 mm or more, or even about 5 mm or more. The one or more openings may have a cross-sectional width of about 30 mm or less, about 25 mm or less, or even about 20 mm or less. A cross-sectional width of an opening may be considered the same as a diameter of an opening.

One or more openings of an electrode plate, end plate, and/or substrate may have a larger diameter than one or more other openings of the same electrode plate, end plate, and/or substrate. An opening may be about at least about 1.5 times, at least about 2 times, or even at least about 2.5 times larger than another opening. An opening may be about 4 times or less, about 3.5 times or less, or even about 3 times or less larger than another opening. The openings may be formed having a density of at least about 0.02 openings per cm². The openings may be formed having a density of less than about 4 openings per cm². The openings may be formed having a density from about 2.0 openings per cm² to about 2.8 openings per cm². The one or more openings may include one or more peripheral openings, one or more internal openings, one or more channel openings, one or more conductive openings, the like, or any combination thereof. The one or more openings may be as disclosed in International PCT Publication No. WO 2018/237381, incorporated by reference herein in its entirety for all purposes.

One or more openings may include one or more channel openings. The one or more channel openings may function to align with one or more other channel openings of one or more electrode plates to form one or more channels; provide an opening for filling and/or venting the battery assembly; providing an opening for circulating one or more fluids within an interior of the battery assembly; cooperate with one or more valves; receive one or more posts to compress the stack of electrode plates; receive one or more channel seals; or any combination thereof. The one or more channel openings may align (i.e., concentric alignment) with one or more other channel openings and/or holes of one or more electrode plates, end plates, and/or separators. Alignment may be in a transverse direction to form one or more channels (e.g., transverse channels) through the stack. The one or more channel openings may have a size substantially equal to one or more channel openings of one or more other electrode plates, end plates, and/or separators. The one or more channel openings may have any size through which one or more posts, rods, fluids, or a combination may pass through. One or more channel openings may have a smaller, equal, or larger cross-sectional width or area than one or more other channel openings. For example, one channel opening may have a larger diameter than one or more other channel openings to allow for filling, venting, cooling, and/or heating of the battery. The larger channel opening may be aligned with other larger channel openings to form one or more channels for filling, venting, cooling, and/or heating. For example, one or more channel openings may have a smaller diameter than one or more other channel openings to allow for retaining one or more posts for compressing a stack of electrode plates. The one or more smaller channel openings may be aligned with other smaller channel openings to form one or more post channels. One or more channel openings may be connected to or in communication with one or more valves. For example, a channel opening having a larger diameter than other channel openings may be connected to a valve. A surface of the base near and/or adjacent to one or more channel openings may be a sealing surface.

One or more openings may include one or more conductive openings. One or more conductive openings may be filled with an electrically conductive material. An electrically conductive material may be a pure metal, alloyed metal, or metallic-containing material. The one or more conductive openings may be formed in one or more electrode plates, end plates, substrates, or a combination thereof. One or more conductive openings may be smaller than or equal in size (e.g., in diameter) to one or more other openings of an end plate, electrode plate, substrate, or a combination thereof.

One or more conductive openings may have a diameter that is about 1% or greater, 5% or greater, 10% or greater, or even about 25% or greater of a diameter of one or more other openings (e.g., channel openings, peripheral openings, internal openings). One or more conductive openings may have a diameter of about 75% or less, about 50% or less, or even about 40% or less of a diameter of one or more other openings. In other words, if a channel opening has a diameter of about 10 mm, a conductive opening may have a diameter of about 1% to about 75% of 10 mm (e.g., 0.1 mm to about 7.5 mm).

The one or more conductive openings may be filled with one or more electrically conductive materials. The electrically conductive material may pass through the conductive opening such as to be in contact with one or more current collectors, current conduits, active masses, the like, or a combination thereof. The electrically conductive material may be a material that undergoes a phase transformation at a temperature that is below the thermal degradation temperature of the substrate so that at an operating temperature of the battery assembly that is below the phase transformation temperature, the dielectric substrate has an electrically conductive path via the material admixture between the first surface and the second surface of the substrate. Further, at a temperature that is above the phase transformation temperature, the electrically conductive material admixture undergoes a phase transformation that disables electrical conductivity via the electrically conductive path. For instance, the electrically conductive material may be or include a solder material. A solder material may comprise at least one or a mixture of any two or more of lead, tin, nickel, zinc, lithium, antimony, copper, bismuth, indium or silver. The electrically conductive material may be substantially free of any lead (i.e., it contains at most trace amounts of lead), or it may include lead in a functionally operative amount. The material may include a mixture of lead and tin. For example, it may include a major portion tin and a minor portion of lead (e.g., about 55 to about 65 parts by weight tin and about 35 to about 45 parts by weight lead). The material may exhibit a melting temperature that is below about 240 °C, below about 230 °C, below about 220 °C, below 210 °C or even below about 200 °C (e.g., in the range of about 180 to about 190 °C). The material may include a eutectic mixture.

The type of electrically conductive material selected to fill the conductive openings can vary depending on whether it is desired to include such an internal shut down mechanism within the battery, and if so at what temperature it is desired to effect such an internal shutdown. The substrate will be configured so that in the event of operating conditions that exceed a predetermined condition, the substrate will function to disable operation of the battery by disrupting electrical conductivity through the substrate. For example, the electrically conductive material filling holes in a dielectric substrate will undergo a phase transformation (e.g., it will melt) so that electrical conductivity across the substrate is disrupted. The extent of the disruption may be to partially or even entirely render the function of conducting electricity through the substrate disabled.

The electrically conductive material may be a solder. A feature of using solder as the electrically conductive material for filling the openings is that the solder has a defined melting temperature that can be tailored, depending on the type of solder used, to melt at a temperature that may be unsafe for continued battery operation. Once the solder melts, the substrate opening containing the melted solder is no longer electrically conductive and an open circuit results within the electrode plate. An open circuit may operate to dramatically increase the resistance within the bipolar battery thereby stopping further electrical flow and terminating unsafe reactions within the battery.

The electrically conductive material which fills the one or more conductive openings may be in the form of a paste (e.g., solder paste), plug, stud, wire, pin, rod, rivet (e.g., traditional rivet), the like, or any combination thereof. The form may refer to the form during initial insertion, after being fully assembled thereto, or both. The electrically conductive material may be referred to as a rivet even if not in a traditional rivet form. For example, the plug, stud, wire, pin, and/or rod may also be referred to as a rivet. Electrically conductive material affixed to a substrate, into a conductive opening, and/or attached to one or more current collectors via a mechanical force may be referred to as a rivet. For example, while typically a paste form may be used affixed via melting (e.g., soldering), in using plugs, studs, wire, rods, pins, rivets and/or the like these forms may be affixed via mechanical force (e.g., press-fit, shrink fit, deformation after insertion). It is also possible that the electrically conductive material is affixed via melting, heating, mechanical force, or any combination thereof. Thus, an electrically conductive material affixed via heat bonding in addition to a mechanical bonding may also be considered a rivet. The electrically conductive material may be affixed using a process similar to that of traditional solid riveting. The electrically conductive material may even include one or more hooks, or one or more barbs, and/or other sharp features formed on one or more ends. The one or more hooks (e.g., or other sharp features) may aid in affixing the electrically conductive material into the conductive opening. The one or more hooks may aid in increasing surface contact with one or more current collectors, active masses, or both. The electrically conductive material may include a solder paste or a solder paste and flux combination. The electrically conductive material may include one or more plugs, studs, wires, and/or rivets comprised of one or more pure metals, metal alloys, or metal containing materials. The one or more metals may include titanium, platinum, pure lead, silver, tantalum, alloys thereof, the like, or any combination thereof.

The one or more electrically conductive materials may have a shape and/or size such that it partially or completely fills the conductive opening upon insertion, allows for a force fit and/or press fit into the conductive opening, partially or completely fills the conductive opening upon deformation (e.g., upon melting and/or force being applied), or any combination thereof. The one or more electrically conductive materials may have a cross-sectional size (e.g., width/diameter) that is less than, about equal to, or greater than a cross-sectional size (e.g., width/diameter) than the conductive opening of which it is inserted to. The cross-sectional size of the electrically conductive material may be less than, about equal to, or greater than the cross-sectional size of the conductive opening prior to insertion, upon initial insertion, after being assembled thereto, or any combination thereof. The cross-sectional size may be substantially uniform or non-uniform along a length of the electrically conductive material. For example, the electrically conductive material may have a tapered cross-sectional size (e.g., narrow end widens to wider end). A tapered design may aid in insertion into a conductive opening. As another example, the electrically conductive material upon assembly to the conductive opening may have a cross-sectional size greater than that of the conductive opening at one or both ends which may protrude from the conductive opening while the portion residing within the conductive opening has an equal size (e.g., completely fills the conductive opening).

The one or more electrically conductive materials may have a length. The length may be such that it is shorter than, about equal to, or greater than a height of the conductive opening, thickness of a substrate, or both into which it is inserted. An advantage of having a length longer than the height of the conductive opening and/or thickness of a substrate is that the electrically conductive material may protrude through the substrate at one or both surfaces. By protruding through, the one or more electrically conductive materials may come into contact with and/or have greater contact with one or more current collectors, active masses, or both (e.g., as opposed to if not protruding through). Greater contact may refer to more surface area of the electrically conductive material being in direct contact with the one or more current collectors, active masses, or both. The one or more electrically conductive materials may be symmetrically or asymmetrically positioned within the conductive opening. Positioning may refer to position relative to the substrate upon insertion, after assembly, or both. Symmetric may mean that about the same amount of length of the electrically conductive materials protrudes from each surface for the substrate. Asymmetric may mean that differing lengths of the electrically conductive materials protrude from each surface of the substrate.

The one or more electrically conductive materials may be in contact with and/or part of one or more current collectors, active masses, or both. The one or more electrically conductive materials may be affixed to, adhered to, part of, in physical contact with, or any combination thereof one or more current collectors, active masses, or both. The one or more electrically conductive materials may be bonded to one or more current collectors, active masses, or both. The one or more electrically conductive materials may be heat bonded (e.g., melt bonded) to one or more current collectors. For example, the electrically conductive material may be melt bonded to a current collector on each side of a substrate. For example, a mechanically affixed rivet may then be heat bonded to the one or more current collectors. It is also possible the one or more electrically conductive materials are in the form of projections from a current collector. The projections may be inserted into the conductive openings. The current collector may be indented to form the projections or otherwise formed to have projections extending therefrom. Simultaneous with or after forming or inserting the projections, the projections may be inserted into the conductive openings.

The one or more electrically conductive materials may include one or more holes formed therein. The one or more holes may function to influence and/or control one or more deformation characteristics during a bonding or other forming process. Deformation may include deformation by temperature, force, and/or the like. The one or more holes may be centered and/or off centered with a longitudinal axis of the electrically conductive material. The one or more holes may be substantially parallel, perpendicular, or any transverse angle therebetween relative to a longitudinal axis of the one or more electrically conductive materials and/or conductive openings. The one or more holes may extend partially and/or completely through the electrically conductive material. The one or more holes may include a single hole or a plurality of holes. If a plurality of holes are present, they may all be in the same direction, differing directions, or both. If a plurality of holes are present, they may or may not intersect with one another.

One or more electrode plates, end plates, separators, or any combination thereof may include one or more inserts. The one or more inserts may function to interlock with one or more inserts of another electrode plate, end plate, separator, or a combination thereof; define a portion of one or more channels passing through the stack; form a leak proof seal along one or more channels; cooperate with one or more valves; provide a housing for one or more rods and/or posts; allow for a fluid to pass therethrough; or any combination thereof. The one or more inserts may have any size and/or shape to align and interlock with one or more inserts of an electrode plate, end plate, and/or separator; form a portion of a channel; form a leak proof seal along one or more channels; cooperate with one or more valves; or any combination thereof. The one or more inserts of one electrode plate, end plate, and/or separator may align and interlock with one or more inserts of an adjacent and/or proximate electrode plate, end plate, and/or separator. For example, an insert of an electrode plate may align and interlock with an insert of a separator adjacent to the electrode plate. As another example, an insert of an electrode plate may align and interlock with an insert of another electrode plate which is in proximity to the electrode plate, such as the opposing electrode plate of the same electrochemical cell.

The one or more inserts may be integral with (e.g., formed therewith, one-piece) or affixed to an electrode plate, end plate, separator, or a combination thereof. The one or more inserts may be integral with or attached to a substrate, base, or both. The one or more inserts may be formed as one or more bosses. An insert which is integral with a surface of an end plate (e.g., base), electrode plate (e.g., substrate), and/or separator and projects from that surface may be defined as a boss.

The one or more inserts may be integrally formed through compressive forming, tensile forming, molding, or the like, or any combination thereof. Compressive forming may include die forming, extrusion, indenting, the like, or any combination thereof. Molding may include injection molding. Where an electrode plate, end plate, and/or separator has both inserts and a frame, raised edges, and/or a recessed portion, these parts may be molded in one step. For instance, an electrode plate, end plate, separator, inserts, frame, raised edges, recessed portion, or any combination thereof may be formed together by a single injection molding operation.

One or more inserts may project from a surface of an end plate, electrode plate, and/or separator thus forming one or more raised inserts. One or more inserts may project from a base of an end plate, substrate of an electrode plate, a surface of a separator, or any combination thereof. One or more inserts may project in a same or opposing direction as one or more rib structures from a base, substrate, or both (e.g., such as in a reinforced end plate or electrode plate). One or more inserts may have the same height and/or thickness as one or more rib structures, one or more other inserts, the frame, or a combination thereof. Height may be measured as the distance projecting away from the face of the base and/or substrate. One or more inserts may project substantially orthogonally or obliquely from a surface of the base, substrate, separator, or a combination thereof.

The one or more inserts may have one or more openings therethrough. The one or more inserts may have one or more peripheral openings, internal openings, channel openings, or a combination thereof therethrough. In other words, these openings formed in the substrate and/or base are also formed in the inserts, continuous through the inserts, or both. The one or more inserts may be concentric or off-center with one or more openings. The one or more inserts may be formed about one or more openings. One or more inserts may extend a length of an opening (e.g., an opening may pass entirely through an insert). An opening may pass entirely through an insert and a substrate. For example, a channel opening may extend through both the substrate and the insert.

A sealing surface may be formed between the outer diameter of one or more openings and an interior of one or more inserts. For example, a surface of the base and/or substrate substantially perpendicular to a longitudinal axis of the battery located between an insert and an opening may be a sealing surface.

One or more inserts may be capable of interlocking with one or more inserts of an adjacent electrode plate, separator, and/or end plate to form a leak proof seal about a channel. For example, one or more end plates and/or electrode plates may be machined or formed to contain matching indents, on a surface opposite from an insert, for inserts, sleeves, or bushings of an adjacent electrode plate and/or separator.

One or more inserts may contain one or more vent holes. Inserts in one or more separators may contain one or more vent holes. The vent holes may allow communication between one or more electrochemical cells and one or more channels. One or more vent holes may allow transmission of gasses from one or more electrochemical cells to one or more channels and prevent the transmission of one or more liquids (i.e., an electrolyte) from one or more electrochemical cells to one or more channels. One or more vent holes may be provided in one or more inserts associated with one or more venting, cooling, and/or filling channels.

One or more of the electrode plates may include or be free of one or more current collectors. The one or more current collectors may function to dispose electrons flowing in the electrochemical cell, ensure electrical connection of one or more active masses to a substrate, collect current, or any combination thereof. The one or more current collectors may have any suitable form or shape to cooperate with one or more active masses of a substrate, transmit or receive electrons from one or more terminals, or both. The one or more current collectors may be in the form of a sheet, foil, grid, screen, mesh, the like, or any combination thereof. The one or more current collectors may be comprised of any one or more materials suitable for conducting current. The one or more materials may include one or more electrically conductive materials. The one or more electrically conductive materials may include one or more metals. The one or more metals may include silver, tin, copper, lead, alloys thereof, the like, or any combination thereof. The one or more materials may be chosen based on the one or more materials selected for the one or more active masses (e.g., cathode, anode, or both). For example, in a lead acid battery, the one or more current collectors may be comprised of a lead, a lead alloy, or both.

The one or more current collectors may be located between a substrate and an active mass, embedded within a substrate, embedded within an active mass, in contact with a substrate, in contact with an active mass, or any combination thereof. For example, a current collector may be located between a substrate and an active mass supported by the substrate. A current collector may be located between only a portion of or an entire surface of an active mass facing toward a substrate. A current collector located between the entire surface of an active mass and a substrate may provide for more efficient current collection and dispersion.

The one or more current collectors may have a thickness sufficient to collect electrons and transmit to current conductors, current conduits, dispose electrons flowing through an electrochemical cell, or any combination thereof. For example, the thickness of the current collector may be about 0.025 mm or greater to about 0.75 mm or less.

One or more current collectors may be affixed to a surface of a substrate. The one or more current collectors may be in direct contact with one or more electrically conductive materials retained by the substrate. The one or more current collectors may be in direct contact with one or more electrically conductive materials located within one or more conductive openings. Any suitable method of affixing a current collector to a substrate may be used which suitably holds the current collector to the substrate before and during repeat operation of the battery assembly. Suitable methods of affixing a current collector to a substrate may include welding, adhesive bonding, the like, or both. For example, a current collector may be bonded to the substrate via one or more adhesives. The one or more adhesives may include one or more epoxies, rubber cements, phenolic resins, nitrile rubber compounds, cyanoacrylate glues, the like, or a combination thereof. A suitable current collector is a lead foil from EppsteinFOILS GmBH & Co. KG having a thickness of 150 microns.

The one or more electrode plates may include one or more active masses. A substrate may have one or more active masses (i.e., anode, cathode) on one or both surfaces. One or more bipolar plates include a substrate having an anode on one surface and a cathode on an opposing surface. One or more bipolar plates may be located between two monopolar plates, a monopolar plate and a dual polar plate, or both. A monopolar plate may include either an anode or a cathode deposited on a surface. A monopolar plate may be free of active mass on a side opposing one with active mass. First and second monopolar plates may be located at opposing ends of the one or more stacks having the bipolar plates, dual polar plates, or both located therebetween.

One or more electrode plates may be the same as or separate from one or more end plates, such as a first end plate and a second plate. The one or more end plates may be attached at one or more ends of the stack. The one or more end plates may be the one or more monopolar plates or separate from the monopolar plates. For example, a first end plate may be attached at an opposing end of the stack as a second end plate. One or more end plates may be particularly useful for reinforcing electrode plates during drawing of a vacuum within the battery assembly, filling of the battery assembly, during operation in a charge and/or discharge cycle of the battery assembly, or any combination thereof. One or more end plates and/or monopolar plates may have an internal reinforcement structure as disclosed in U.S. Pat. No. 10,141,598, incorporated herein by reference in its entirety. One or more electrode plates may have one or more features as disclosed in PCT Publication No: WO2018/0213730, incorporated herein by reference in its entirety.

The one or more active masses may comprise one or more materials typically used in secondary batteries. Secondary batteries may include lead acid, lithium ion, and/or nickel metal hydride batteries. The one or more active masses may comprise a composite oxide; a sulfate compound; a phosphate compound of lithium, lead, carbon, graphite, nickel, aluminum, or a transition metal; or any combination thereof. Examples of composite oxides include Li/Co based composite oxide, such as LiCoO₂; Li/Ni based composite oxide, such as LiNiO₂; Li/Mn based composite oxide, such as spinel LiMn₂O₄, and Li/Fe based composite materials, such as LiFeO₂. Exemplary phosphate and sulfur compounds of transition metal and lithium include LiFePO₄, V₂O₅, MnO2, TiS₂, MoS₂, MoO₃, PbO₂, AgO, NiOOH, FeSO₄, Na₂SO₄, MgSO₄ and the like. For example, in a lead acid battery, the one or more active masses may be or include lead dioxide (PbO2), tribasic lead oxide (3PbO), tribasic lead sulfate (3PbO·PbSO₄), tetrabasic lead oxide (4PbO), tetrabasic lead sulfate (4PbO·PbSO₄), or any combination thereof.

The one or more active masses may be in any form which allows the one or more active masses to function as a cathode, anode, or both of an electrochemical cell. Exemplary forms include formed parts, in paste form, prefabricated sheet or film, sponge, or any combination thereof. For example, one or more active masses may include a sponge lead. Sponge lead may be useful due to its porosity. One or more suitable active masses and/or forms thereof may be described in PCT Publication Nos. WO 2018/0213730 and WO 2020/0102677, incorporated herein by reference in their entirety for all purposes.

### Forming Electrically Conductive Substrate Assembly

A method for forming an electrically conductive substrate assembly of an electrode plate comprising: a) forming a non-conductive substrate with a plurality of conductive openings; b) filling one or more of the plurality of conductive openings with one or more electrically conductive materials; c) locating one or more current collectors on one or more surfaces of the substrate; d) optionally, bonding the one or more electrically conductive materials to the one or more current collectors; and wherein the one or more electrically conductive materials are in the form of one or more rivets.

The present disclosure may relate to a method of forming an electrically conductive substrate assembly. The method may be applicable to the electrode plate and substrate according to the teachings herein. The method may include forming one or more substrates. The substrates may be one or more non-conductive substrates. The method may include forming one or more frames, inserts, and/or other non-planar structures. Forming of the one or more frames, inserts, and/or other non-planar structures may be simultaneous with or separate from forming of the substrate. The method may include forming one or more openings. Forming one or more openings may be simultaneous with or separate from forming the substrate. The method may include filling one or more openings (e.g., conductive openings) with one or more electrically conductive materials. The method may include or be free of (e.g., optionally) assembling one or more current collectors to one or more substrates.

The method may include forming one or more substrates. The one or more substrates may be formed with or have affixed thereto one or more inserts, frames, and/or other non-planar structures. The one or more substrates, frames, inserts, may be formed according to any suitable methods disclosed herein. Suitable methods for forming one or more substrates, frames, and inserts are discussed in PCT Publications WO 2013/062623, WO 2018/213730, WO 2018/237381, and WO 2020/102677; U.S. Pat. Nos. 8,357,469; 10,141,598, 10,615,393; and US Patent Publication No.: 2019/03790361 incorporated herein by reference in their entirety for all purposes.

The method may include forming one or more openings in the substrate. The one or more openings may include one or more channel openings, conductive openings, one or more peripheral openings, one or more internal openings, the like, or a combination thereof. The one or more openings may be formed as disclosed herein. The one or more openings may be machined, formed during fabrication of the substrate, or otherwise fabricated.

The method may include filling one or more conductive openings with one or more electrically conductive materials. Filling of multiple conductive openings of an electrode plate may occur simultaneously, sequentially, other variation, or a combination thereof. Filling may include inserting, bonding, or both. Filling may include inserting a paste, plug, stud, wire, pin, rod, and/or the like into a conductive opening. Filling may include bonding one or more electrically conductive materials to the substrate. Inserting and bonding may be completed in a single step or multiple steps. In other words, bonding may be simultaneous, near simultaneous, or after inserting. Other steps of forming the electrode plate may occur between the inserting and the bonding.

Inserting may be part of a mechanical bonding process and/or heat bonding process or separate therefrom. One or more electrically conductive materials may be inserted (e.g., located into) the one or more conductive openings by piercing, press-fitting, shrink fitting, melting, the like, or a combination thereof. Piercing may involve piecing through a current collector to be inserted into a conductive opening. Inserting of the electrically conductive material (e.g., rivet) into the conductive opening may be prior to, simultaneous with, or after placement of one or more current collectors on a substrate.

Inserting may be separate from the bonding process. In other words, the electrically conductive material may be first inserted into a conductive opening via an insertion means and then subsequently bonded. For example, one or more current collectors may be pierced, stamped, indented, and/or the like. One or more projections from one or more current collectors may be inserted into one or more conductive openings. Insertion may be simultaneously with or after placement of a current collector onto a surface of a substrate.

Bonding may include mechanical bonding, heat bonding, or both one or more electrically conductive materials to the substrate. Filling may include mechanical bonding, heat bonding, or both to an interior surface of the one or more conductive openings, one or more surfaces (e.g., faces) of a substrate, or both. Heat bonding may refer to soldering or other melt bonding methods. Mechanical bonding may refer to mechanical pressing, shrink fitting, piercing, the like, or any combination thereof. The electrically conductive material may be referred to as a solder joint, rivet, or both. It is possible to simultaneously be a solder joint and a rivet. Electrically conductive material which is bonded to the substrate via mechanical bonding methods may be referred to as a rivet. Even if heat bonding methods are also employed, if mechanical bonding methods are used, the electrically conductive material may be referred to as a rivet.

Bonding the electrically conductive material (e.g., rivet) to a substrate may use the same process or a different process as bonding one or more current collectors to the substrate. Bonding the electrically conductive material to the substrate may be done before, simultaneous with, or after bonding of one or more current collectors to the substrate.

The rivet may have one or two ends which protrude from one or both sides of the conductive opening. In other words, have a length greater than the length of the opening and/or thickness of the substrate. The rivet may be mechanically pressed from one side or both ends. The mechanical force may result in volumetric expansion of the rivet due to material displacement to fill the conductive opening of which it is inserted into.

Mechanical pressing may occur before or after one or more current collectors are located on a substrate or in the absence of current collectors as part of the electrode plate. Upon being pressed, the rivet may deform at one or both ends. Upon deformation, the one or more opposing ends may spread and overlap with one or more surfaces of the substrate. Upon overlapping, one or more opposing ends of the rivet may cover the conductive opening. In other words, deforming, the exterior ends of the stud/plug may have a diameter/width larger than the diameter/width of the conductive opening. A rivet may be mechanically pressed after one or more current collectors are located on one or both surfaces of the substrate. This may allow for cladding to occur between the current collector and the one or more studs and/or plugs.

The rivet prior to insertion may have a cross-sectional size larger than the cross-sectional size of the conductive opening. The rivet may shrink fit into the one or more conductive openings. Shrink fitting may involve heating the rivet and/or substrate and then cooling the rivet and/or substrate. Heating and cooling may be achieved via any known means. Cooling may involve no additional means aside from allowing the rivet to return to ambient temperature. Shrink fitting may occur prior to or simultaneous with placement of one or more current collectors. Shrink fitting may be simultaneous with placement of one or more current collectors in the case the one or more rivets are in the form of one or more projections from the current collector. Shrink fitting may occur prior to placement of one or more current collectors in the case the one or more rivets are separate from the current collector. Shrink fitting may allow for shrinking of the substrate and expansion of the stud during thermal equilibration to ambient temperature (e.g., upon cooling) to create an interference between the rivet and the conductive opening, thereby filling the conductive opening.

The electrically conductive material may be melt bonded to the substrate. Melt bonding may occur simultaneously with or after insertion of the electrically conductive material into the conductive opening. Melt bonding may refer to melting of the electrically conductive material, substrate, or both. For example, in typical soldering, the electrically conductive material approaches a melting point and flows to create the bonded joint. For example, melting or otherwise approaching melting point of the substrate around the stud to allow for flowing of the substrate materials to fill the gap between the stud and the substrate.

The energy applied to allow the one or more electrically conductive materials to fill the one or more conductive openings may include heat, mechanical, sonic, focused energy (e.g., laser), the like, or a combination thereof. The energy may generate heat.

The one or more substrates may have one or more current collectors assembled thereon. The one or more current collectors may be placed onto one or more substrates prior to, simultaneous with, or after insertion and/or bonding of one or more electrically conductive materials within one or more conductive openings. For example, a current collector in the form of a foil, may be placed on top of a plurality of electrically conductive materials in the form of studs.

One or more current collectors may be placed in electrical connection with and/or bonded to one or more electrically conductive materials. Electrical connection may be via contact, bonding, or both. The electrical connection may be formed via mechanical bonding, heat bonding, or both. The mechanical bonding and/or heat bonding of the current collector to the electrically conductive material may be prior to, simultaneous with, or after the mechanical bonding and/or heat bonding of the electrically conductive material to the substrate. For example, the electrical connection may be formed via cold welding. Cold welding may occur while press-fitting. For example, the electrical connection may be formed via cold welding in the form of cladding while a press-fit is created. For example, the electrical connection may be formed via heat welding. Heat welding may occur when melting a portion of the electrically conductive material, substrate, and/or current collector to cause a bond.

One or more current collectors may also form the one or more electrically conductive materials. For example, one or more current collectors may be deformed and placed into the one or more conductive openings. Deforming may be completed by puncturing, heat staking, embossing, the like, or any combination thereof. One current collector could be deformed so as to deform into all of the plurality of conductive openings, or both current collectors could be deformed so as to deform into all of the plurality of conductive openings. For example, the deformations (projections into) of opposing current collectors may come into contact with one another. As another example, the deformations may alternate throughout. It is also foreseeable that the current collector could extend through the one or more conductive openings and come into contact with one or more active masses.

Once a substrate (e.g., non-conductive substrate) has been filled with electrically conductive material and optionally, has one or more current collectors thereon, the substrate may be referred to as an electrically conductive substrate assembly, conductive substrate assembly, or both.

### Forming an Electrode Plate With an Electrically Conductive Substrate Assembly

The present disclosure may be useful in disclosing a method for forming an electrode plate. The method may include any of the steps included for forming an electrically conductive substrate assembly. The method may include applying one or more active masses to the electrically conductive substrate assembly.

Application of one or more active masses thereon may occur after application of the electrically conductive materials, current collectors, or both. Application of one or more active masses may occur as taught in US Patent Publication Nos. 2020/0091521, 2021/0143514, and 2022/0013760 incorporated by reference hereinafter in its entirety for all purposes. For example, the active mass may be applied thereon via pasting, a transfer sheet process, or both.

### WORKING EXAMPLES

Example 1: One or both sides of the substrate are tacked with a current collector in the form of a foil (e.g., adhered thereto). A rivet press is loaded with a sufficient number of rivets to fill all or some of the plurality of conductive openings of a substrate. The substrate with the current collectors thereon is located in the rivet press. The rivet press is cycled. During cycling, a top plate lowers, forcing rivets through the current collector (e.g., piercing) and into the conductive openings of the substrate. The top plate of the rivet press may have a rivet cup feature to seal the plurality of rivets by force. An assembled conductive substrate assembly is unloaded from the rivet press. A conductive substrate assembly may be a conductive substrate assembly once conductive materials are assembled therein and on (e.g., electrically conductive material in conductive openings, current collectors) and before one or more active masses are located thereon such as to form an electrode plate.

Example 2: One or both sides of the substrate have the current collectors located thereon in the form of a foil (e.g., stacked together). The current collectors are pierced to create openings which align with the conductive openings. The current collectors are pierced with a syringe or lead wire. The syringe or lead wire may pierce through just one current collector or both opposing current collectors. The lead wire is inserted and located into its respective conductive opening. In other words, the lead wire is the electrically conductive material. The lead wire is then cut to a length such that it is longer than the length/thickness of the conductive opening (e.g., protrudes at one or more both ends of the opening). The lead wire is bent (e.g., forms a hook) and overlaps the current collector. By overlapping, the lead wire sandwiches the current collector onto the substrate. The substrate, current collectors, and wires pass through a heat bonding process to create one or more riveted joints. The heat bonding process may include a heating press, resistance weld, ultrasonic weld, the like, or a combination thereof. The riveted joint(s) may then not only function as electrically conductive paths but also as mechanically pinning the current collectors to the substrate and thus forming an assembled conductive substrate.

Example 3: One or more electrically conductive materials in the form of one or more plugs and/or studs is inserted into the one or more conductive openings of a substrate. Inserting involves pushing (e.g., press fitting). The one or more electrically conductive materials are then welded to the substrate. Welding may include spin welding or other processes which creates a friction weld. The welding may weld the electrically conductive material to the inner surface of the conductive opening and thus to the substrate. One or more current collectors are placed on one or both surfaces of the substrate. The current collector is then pressed onto the surface and thus bonds with the electrically conductive material. It is also foreseeable that the current collector and the electrically conductive material could be heated such as to form a melt bond (e.g., welding or otherwise).

### ILLUSTRATIVE EXAMPLES

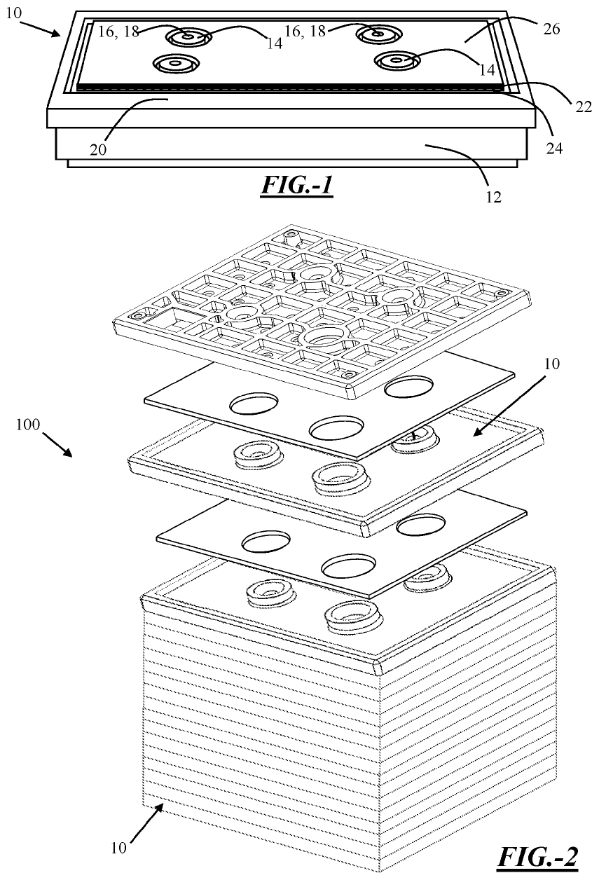

FIG. 1 illustrates an electrode plate 10. The electrode plate 10 includes a substrate 12. The electrode plate 10 includes a plurality of inserts 14. The inserts 14 may be part of the substrate 12. The electrode plate 10 includes a plurality of openings 16. The openings 16 are channel openings 18. The channel openings 18 pass through both the inserts 14 and substrate 12. Located about the substrate 12 is a frame 20. The frame 20 and/or inserts 14 are part of (e.g., integrally formed, one-piece, same material) with the substrate 12. Located on the substrate 12 are one or more active masses 22. Between the active mass 22 and the substrate 12 is a current collector 24. The active mass 22 may have a transfer sheet 26 or separator thereon.

FIG. 2 illustrates an exemplary battery assembly 100 prior to being fully assembled. The battery assembly 100 includes a stack of electrode plates 10.

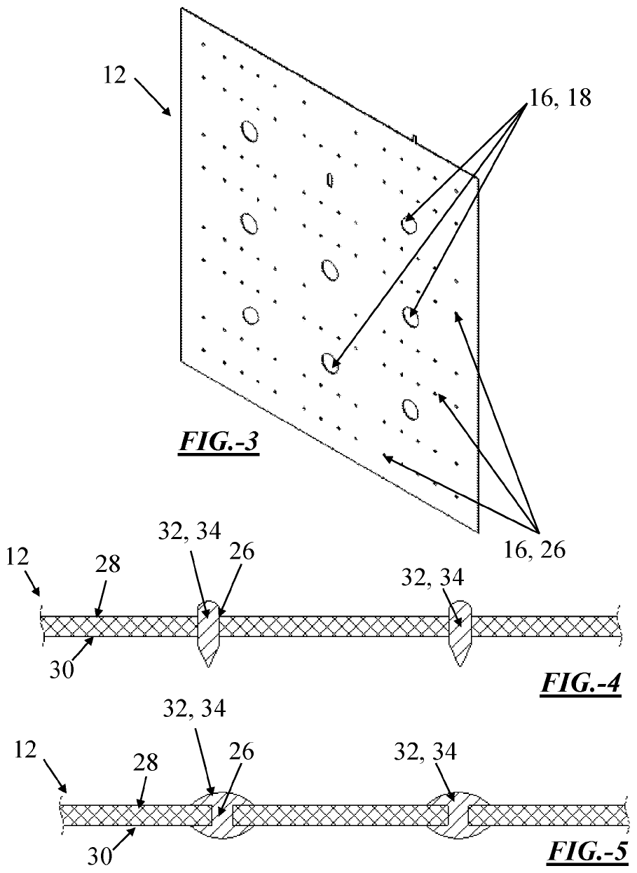

FIG. 3 illustrates a substrate 12. The substrate 12 includes a plurality of openings 16. The openings 16 include channel openings 18. The openings 12 include conductive openings 26.

FIG. 4 illustrates a cross-section of a substrate 12. The substrate 12 includes opposing surfaces 28, 30 (e.g., first surface 28, second surface 30). The substrate 12 includes a plurality of conductive openings 26. Located within the conductive openings 26 is electrically conductive material 32. The electrically conductive material 32 is in the form of one or more rivets 34. The one or more rivets 34 protrude from the conductive opening 26. The one or more rivets 34 protrude beyond both surfaces 28, 30 of the substrate 12.

FIG. 5 illustrates a cross-section of a substrate 12. The substrate 12 includes opposing surfaces 28, 30. The substrate 12 includes a plurality of conductive openings 26. Located within the conductive openings 26 is electrically conductive material 32. The electrically conductive material protrudes 32 from both surfaces 28, 30 of the substrate 12. The electrically conductive material 32 overlaps the opposing surfaces 28, 30 of the substrate 12. The electrically conductive material 32 is in the form of a rivet 34. The rivet 34 has been deformed to bond to the substrate 12.

It is also foreseeable that the substrate 12 of either FIGS. 4 and 5 may have a current collector 24 (not shown) located thereon. In FIG. 4, the current collector 24 may be located atop both the substrate 12 and the rivets 34 and in contact with the protruding ends of the rivets 34. In FIG. 5, the rivet 34 may overlap the current collector 24 such that it is sandwiched between the rivet 34 and the substrate 12.

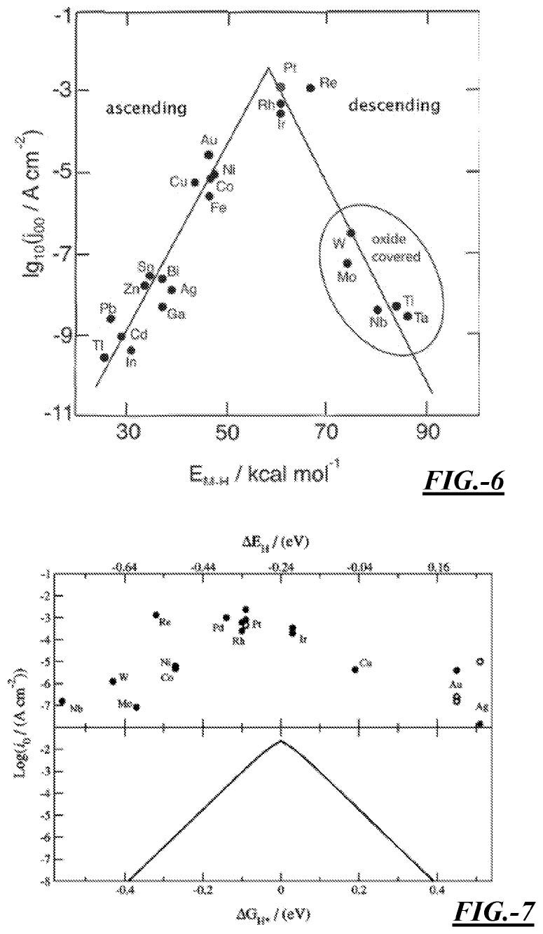

FIGS. 6 and 7 illustrate a volcano plot for elements used in battery assemblies, such as lead acid battery assemblies. Elements found on the ascending side of the pyramid are known for accelerating corrosion and/or oxidation within the battery assembly. Elements found at or near the top of the pyramid are well-established elements which may catalytically produce hydrogen. Elements found on the descending side of the pyramid are known to produce hydrogen gas but only at the extreme potentials in flooded applications. The potentials are greater than that of lead and during normal application will not result in the production of hydrogen, thus making these elements great options for materials.

### REFERENCE NUMBER LISTING

10—Electrode plate
12—Substrate
14—Insert
16—Opening
18—Channel opening
20—Frame
22—Active mass
24—Current collector
26—Conductive openings
28—First surface
30—Second surface
32—Electrically conductive material
34—Rivet
100—Battery Assembly

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A method for forming an electrically conductive substrate assembly of an electrode plate comprising:
a) forming a substrate, which is non-conductive, with a plurality of conductive openings, wherein the substrate is configured is surrounded by a frame and the frame is adapted to stack with an adjacent electrode plate;
b) filling one or more of the plurality of conductive openings with one or more electrically conductive materials, wherein the filling includes inserting the one or more electrically conductive materials into the one or more of the plurality of conductive openings;
c) locating one or more current collectors on one or more surfaces of the substrate;
d) bonding the one or more electrically conductive materials to the one or more current collectors; and
wherein the one or more electrically conductive materials are in the form of one or more rivets.

2. The method of claim 1, wherein the locating of the one or more current collectors on one or more surfaces of the substrate occurs before or after filling the one or more of the plurality of conductive openings with the one or more electrically conductive materials.

3. (canceled)

4. The method of claim 1, wherein the one or more rivets are inserted into one or more of the plurality of conductive openings by, press-fitting, shrink fitting, melting, or a combination thereof.

5-6. (canceled)

7. The method of claim 2, wherein the one or more current collectors includes a first current collector and a second current collector;
wherein the one or more rivets are inserted into the one or more of the plurality of conductive openings after placement of the first current collector; and
wherein the one or more rivets are inserted into the one or more of the plurality of conductive openings prior to placement of the second current collector onto the substrate.

8-10. (canceled)

11. The method of claim 1, wherein the one or more rivets are in the form of a plug, stud, wire, pin, rod, or any combination thereof; and
wherein the one or more rivets are tapered to aid in insertion into the one or more of the plurality of conductive openings.

12. (canceled)

13. The method of claim 1, wherein the one or more rivets are separate from the one or more current collectors.

14. The method of a claim 1, wherein the filling includes bonding of the one or more electrically conductive materials to the substrate, the one or more current collectors, or both.

15. The method of claim 14, wherein the bonding includes mechanical bonding, heat bonding, or both the one or more electrically conductive material to the substrate, the one or more current collectors, or both.

16. The method of claim 14, wherein the one or more rivets are bonded to the substrate via press-fitting, shrink fitting, melt bonding, welding, cladding, or a combination thereof.

17-20. (canceled)

21. The method of claim 15, wherein the one or more rivets are bonded to the one or more current collectors after the one or more rivets are bonded to the substrate using a different process as the bonding to the substrate.

22. The method of claim 1, wherein the one or more electrically conductive materials for the one or more rivets may include titanium, platinum, pure lead, silver, tantalum, alloys thereof, or any combination thereof.

23. The method of claim 1, wherein the one or more electrically conductive materials may have a width which is smaller than, about equal to, or larger than the width of the plurality of conductive openings prior to insertion into the one or more of the plurality of conductive openings.

24. (canceled)

25. The method of claim 1, wherein the substrate is formed via molding; and
wherein the frame, and optionally, one or more inserts, are formed in a same molding process as the substrate to be integral therewith and form a one-piece structure.

26. (canceled)

27. The method of claim 1, wherein the substrate is comprised of one or more polymers.

28. The method of claim 27, wherein the one or more polymers include one or more thermoset polymers, elastomeric polymers, thermoplastic polymers, or any combination thereof.

29. (canceled)

30. The method of claim 25, wherein the substrate includes one or more channel openings formed therein which remain free of the one or more electrically conductive materials;
wherein the one or more channel openings are formed in the one or more inserts which project from one or more surfaces of the substrate; and
wherein the same molding process also includes forming of the one or more inserts.

31. (canceled)

32. The method of claim 30, wherein the one or more channel openings are configured to align with one or more other channel openings of other substrates to form one or more channels through a battery assembly; and
wherein the one or more inserts are configured to align and interlock with one or more other inserts of adjacent or proximate inserts to form the one or more channels which transverse across the battery assembly and provide a seal about the one or more channels.

33. (canceled)

34. The method of claim 1, wherein the method includes the electrically conductive substrate assembly being formed into the electrode plate by locating one or more active masses on electrically conductive substrate assembly.

35. (canceled)

36. The method of claim 34, wherein the one or more active masses are disposed thereon via pasting directly onto the electrically conductive substrate assembly or pasting onto a transfer sheet and then placing onto the electrically conductive substrate assembly.

37. A method for forming an electrically conductive substrate assembly of an electrode plate comprising:
a) forming a substrate, which is non-conductive, with a plurality of conductive openings, wherein the substrate is configured is surrounded by a frame and the frame is adapted to stack with an adjacent electrode plate;
b) filling one or more of the plurality of conductive openings with one or more electrically conductive materials, wherein the filling includes inserting the one or more electrically conductive materials into the one or more of the plurality of conductive openings;
c) locating one or more current collectors on one or more surfaces of the substrate;
d) bonding the one or more electrically conductive materials to the substrate through mechanical bonding, heat bonding, or both;
e) bonding the one or more electrically conductive materials to the one or more current collectors through heat bonding; and
wherein the one or more electrically conductive materials are in the form of one or more rivets, and
wherein the one or more rivets are in the form of a plug, stud, wire, pin, rod or a combination thereof.
